(19) United States
(12) Patent Application Publication
(10) Pub. No.: US 2016/0309693 A1
(43) Pub. Date: Oct. 27, 2016

(54) METHODS OF REMOVING A FISHING LURE AND DEVICES FOR USE THEREIN

(71) Applicant: CLAM CORPORATION, Rogers, MN (US)

(72) Inventor: John M. LaHood, Waconia, MN (US)

(21) Appl. No.: 14/695,381

(22) Filed: Apr. 24, 2015

(51) Int. Cl. A01K 97/18; A01K 99/00

(52) U.S. Cl. CPC A01K 97/18; A01K 99/00

(57) ABSTRACT

Methods of removing a fishing lure and devices for use therein are disclosed. The methods include gripping a fishing lure between coverings on first and second arms of a fishing lure remover that is movable between a first position and a second position. The coverings are constructed of pliable material, and the fishing lure remover engages and grips the fishing lure between the coverings and maintains the surface finish of the fishing lure while moving the fishing lure from a first location to a second location.

### TECHNICAL FIELD

The present disclosure pertains to the field of fishing and fishing equipment. More specifically, the present disclosure pertains to methods of gripping fishing lures and removing fishing lures from a hooked position without damaging the lures, along with devices for use therein.

### BACKGROUND

A wide variety of fishing equipment has been developed for fishing and methods related to fishing. Some of these devices include fishing lures and equipment designed to be used with fishing lures. These devices are manufactured by any one of a variety of different manufacturing methods and may be used according to any one of a variety of methods. Of the known fishing devices and methods, each has certain advantages and disadvantages. There is an ongoing need to provide alternative fishing equipment, as well as alternative methods for manufacturing and using fishing equipment.

### BRIEF SUMMARY

This disclosure is directed to several alternative or complementary designs of, materials of, and methods of using a fishing lure remover for gripping fishing lures and removing fishing lures from a hooked position without damaging the lure.

Accordingly, one illustrative instance of the disclosure may include a method of gripping a fishing lure. The method may include engaging a fishing lure with a portion of a first arm having a covering that is constructed of a pliable material, engaging the fishing lure with a portion of a second arm having a covering that is constructed of a pliable material, and holding the fishing lure between the coverings on the first and second arms, while moving the fishing lure from a first location to a second location.

In another instance, the disclosure may include a method of removing a fishing lure from a fish with a fishing lure remover. The method may include gripping a fishing lure at least partially hooked in a fish between a covering on at least a portion of a first end of a first arm of a fishing lure remover and a covering on at least a portion of a first end of a second arm of the fishing lure remover, wherein the coverings are constructed of a pliable material and the first arm is coupled to the second arm. The method also includes removing the fishing lure from the fish while gripping the fishing lure between the coverings on the respective first and second arms.

In another instance, the disclosure may include a fishing lure remover configured to grip a fishing lure while maintaining a surface finish on the fishing lure. The fishing lure remover may include a first arm having a first end including an elongated portion terminating in a distal tip and a second end including a finger grip, wherein at least a portion of the first arm is constructed of a rigid material. Further, the fishing lure remover may include a second arm having a first end including an elongated portion terminating in a distal tip and a second end including a finger grip, wherein at least a portion of the second arm is constructed of a rigid material. Further, the second arm may be coupled to the first arm between the respective first ends and second ends so as to be pivotally movable between a first position and a second position. The fishing lure remover also may include coverings on the distal tips of the respective first ends of the first and second arms, wherein the coverings are constructed of a pliable material. Additionally, when the first and second arms are in the second position, the coverings are configured to releasably grip a fishing lure while maintaining a surface finish on the fishing lure.

It is to be understood that both the foregoing general description and the following detailed description are exemplary and provided for purposes of explanation only, and are not restrictive of the subject matter claimed. Further features and objects of the present disclosure will become more fully apparent in the following description of the preferred embodiments and from the appended claims.

### BRIEF DESCRIPTION OF DRAWINGS

In describing the preferred embodiments, reference is made to the accompanying drawing figures wherein like parts have like reference numerals, and wherein:

FIG. 1 is a perspective view of a first example fishing lure remover in a first position according to an aspect of the disclosure;

FIG. 2 is a perspective view of the first example fishing lure remover of FIG. 1 in a second position;

FIG. 3 is a side view of an example fishing lure including a surface finish;

FIG. 4 is a schematic view of the example fishing lure of FIG. 3 hooked to the lip of a fish;

FIG. 5 is a schematic view of the example fishing lure of FIG. 3 hooked within the body cavity of a fish;

FIG. 6 is a schematic view of an the example fishing lure having a damaged surface finish;

FIGS. 7A and 7B are perspective views of a second example fishing lure remover being used to engage, grip and remove a fishing lure from the body cavity of a fish.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

For the following defined terms, these definitions shall be applied, unless a different definition is given in the claims or elsewhere in this specification. As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings. The drawings, which are not necessarily to scale, depict illustrative embodiments and are not intended to limit the scope of the invention.

Fishing is a sport that incorporates the use of a variety of fishing tackle in conjunction with a variety of fishing techniques to catch fish. For example, anglers may combine a particular bait (e.g., live bait and/or artificial bait) with a particular fishing technique to target catching a particular type of fish.

In some cases, the use of bait may include the use of a fishing lure (e.g., artificial bait). A fishing lure may be fabricated with a variety of materials, shapes, and surface finishes (e.g., paints, textures, stains, and/or other surface finishes, or the like). Typically, an angler may select a particular fishing lure in hopes that one or more features of the lure (e.g., material and/or surface finish) will entice a fish to attack and/or bite the lure, thereby resulting in a hooked fish. Once hooked, the angler may retrieve the lure along with the hooked fish. Eventually, the angler may attempt to remove the fishing lure from the hooked fish.

In some cases a hooked lure may require an angler to utilize specialized equipment to remove the fishing lure from the fish. However, in some instances the device, force, technique, and/or methodology employed to reach, engage and remove the fishing lure may damage the fishing lure. For example, using a device to reach into the mouth of a fish and to engage, grip and remove a fishing lure may damage and/or remove a portion of the surface finish of the fishing lure. This may be particularly problematic with lures that are made of materials that result in a surface finish that is not as well adhered and/or not highly durable. For instance, more recently, it has been recognized that the use of tungsten to make jig lures is advantageous for reasons relating to the weight and responsiveness of the lures. However, surface finishes that include paint or other materials applied to lures made of tungsten have had a tendency to be more susceptible to damage. Also, the heat treating during manufacturing can cause the hooks of such lures to be more easily bent than on lures made from more conventional materials.

In addition, there may be circumstances that tend to exclude use of certain equipment. For instance, an attempt by an ice fishing angler to grasp an all metal lure remover in sub-freezing temperatures may result in injury to the hands or fingers. Wet hands or fingers may become frozen to the lure remover, risking loss of skin. Additionally, the size of a lure remover could be problematic when working with particularly small-mouthed fish, and sharp edges on a lure remover could present a risk of injury to the fish.

The methods and devices disclosed herein are designed to overcome at least some of the disadvantages of prior art lure removers and some of the limitations of existing methodologies and devices that may damage fishing lures upon removal from a fish, or perhaps injure an angler or the fish. For example, some of the methods disclosed herein may include (e.g., while fishing or ice fishing) engaging a fishing lure with a fishing lure remover having coverings constructed of a pliable material adapted to preserve and/or maintain the surface finish on the fishing lure, while the device may additionally include covered finger grips for added comfort and to protect an ice fishing angler's skin on the hands and fingers.

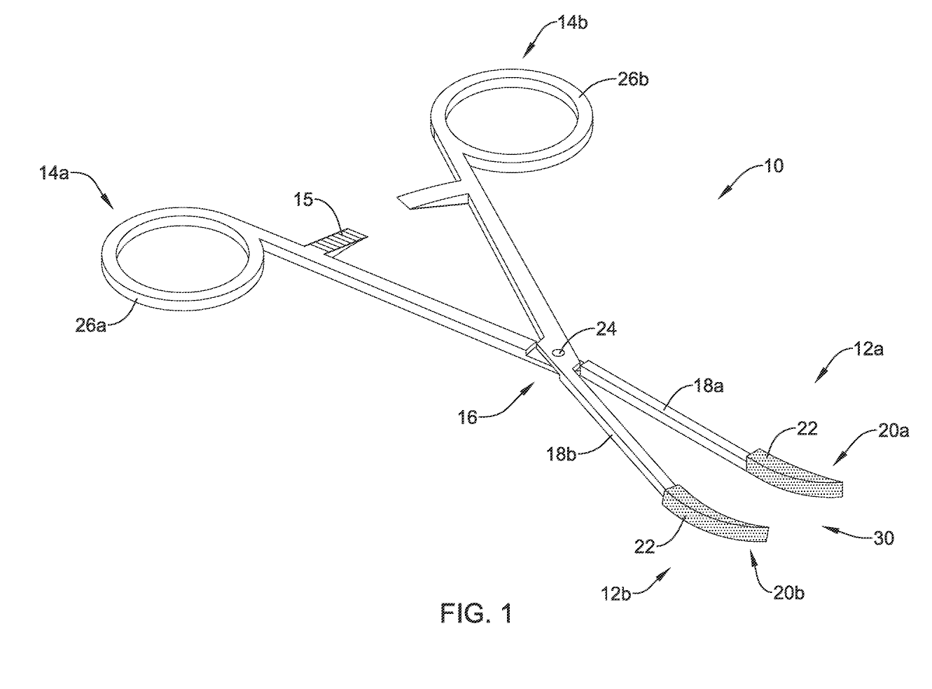

FIG. 1 shows a first example fishing lure remover 10. Fishing lure remover 10 may include a first elongated member or first arm 18a and a second elongated member or second arm 18b. First arm 18a and second arm 18b may have first ends 12a, 12b and second ends 14a, 14b, respectively. In some instances, first ends 12a, 12b may be referred to as the distal ends of first and second arms 18a, 18b. Similarly, second ends 14a, 14b may be referred to as the proximal ends of first and second arms 18a, 18b.

First and second elongated members 18a, 18b may be coupled together. In one example, first and second arms 18a, 18b may be coupled together at coupling region 16, where the coupling region 16 may include pivot 24. Pivot 24 may be positioned between first ends 12a, 12b and second ends 14a, 14b. In some cases, pivot 24 may be considered a central joint about which first and second arms 18a, 18b may rotate or pivot. Alternatively, pivot 24 may be located proximate one of the first ends 12a, 12b or the second ends 14a, 14b.

In some instances, pivot 24 may be constructed by joining a portion of first or second arm 18a, 18b with a corresponding mating portion of the other of the first or second arm 18a, 18b. Pivot 24 alternatively may be constructed as a rivet, screw or other suitable fastener. Also, first and second arms 18a, 18b may include a variety of different shapes and configurations alone or including a pivot 24.

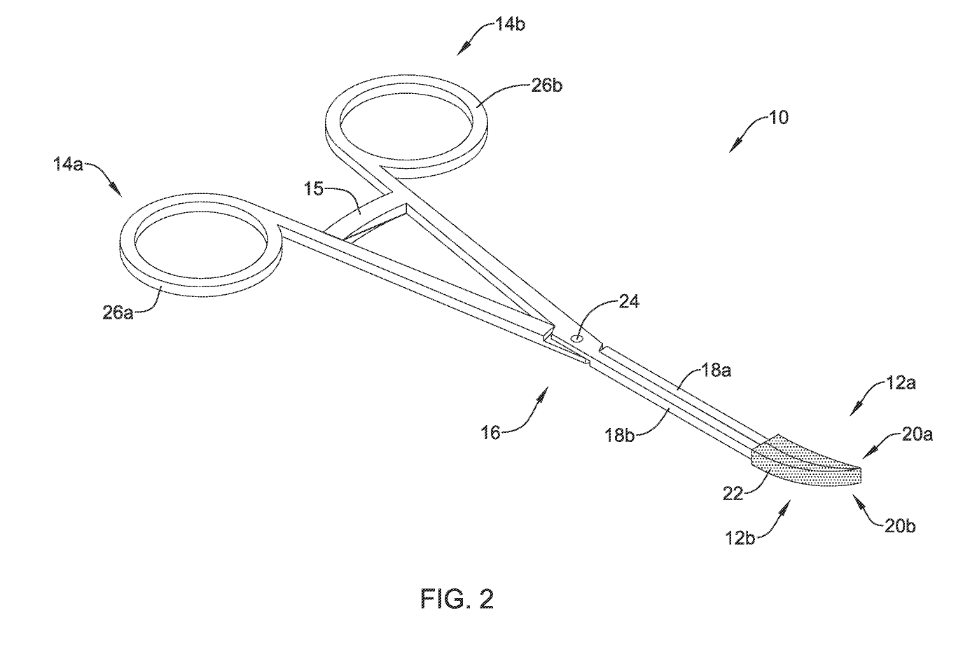

First and second arms 18a, 18b may include tip portions 20a, 20b. Tip portions 20a, 20b may be located at the distal portion of first ends 12a, 12b. As shown in FIG. 1, distal tip portions 20a, 20b may include a curve and/or arcuate shape, but this is not required and one or more of the tip portions 20a, 20b may be generally straight and/or may have a different shape. Further, tip portions 20a, 20b may taper from a proximal to a distal end. Fishing lure remover 10 of FIGS. 1 and 2 is an example, and it is contemplated that tip portions 20a, 20b may include a variety of slopes, bends, curves, hooks, angles, etc.

Tip portions 20a, 20b and/or other portions of the fishing lure remover 10 may include coverings. In some instances the coverings may be constructed of a pliable material. For example, coverings 22 are shown on tip portions 20a, 20b in FIGS. 1 and 2. Also, coverings 22 may be applied in the form of a coating, whether applied by dipping, spraying or other suitable method, or may be configured as sleeves or caps that slide over the respective distal tip portions 20a, 20b at the first ends 12a, 12b of arms 18a, 18b while being connected thereto by interference or shrink fit, adhesive or other suitable means of connection.

First and second arms 18a, 18b may be constructed of a variety of materials. In the embodiments contemplated herein, arms 18a, 18b may be constructed of a rigid material such as metal, metal alloy, polymer, plastic, ceramic, composite or other material that is more rigid than the pliable material of coverings 22. A rigid material may resist deformation and/or minimize undesirable flexing of the arms 18a, 18b when fishing lure remover 10 is closed and/or gripping an object.

For example, a rigid material may add stiffness and/or rigidity which may be beneficial when manipulating fishing lure remover 10. Further, a stiff or rigid fishing lure remover 10 may increase the dexterity of the user when attempting to control the fishing lure remover 10 with a certain degree of precision.

As depicted in FIG. 1, second ends 14a, 14b of first and second arms 18a, 18b may include finger grips 26a, 26b, which may be in the form of rings, such as shown in FIG. 1, or bends, etc. Finger grips 26a, 26b may be designed to permit a user's fingers to be inserted thereat to grip the fishing lure remover 10. Additionally, finger grips 26a, 26b may permit a user to manipulate or shift the position of the fishing lure remover 10 from a first position to a second position.

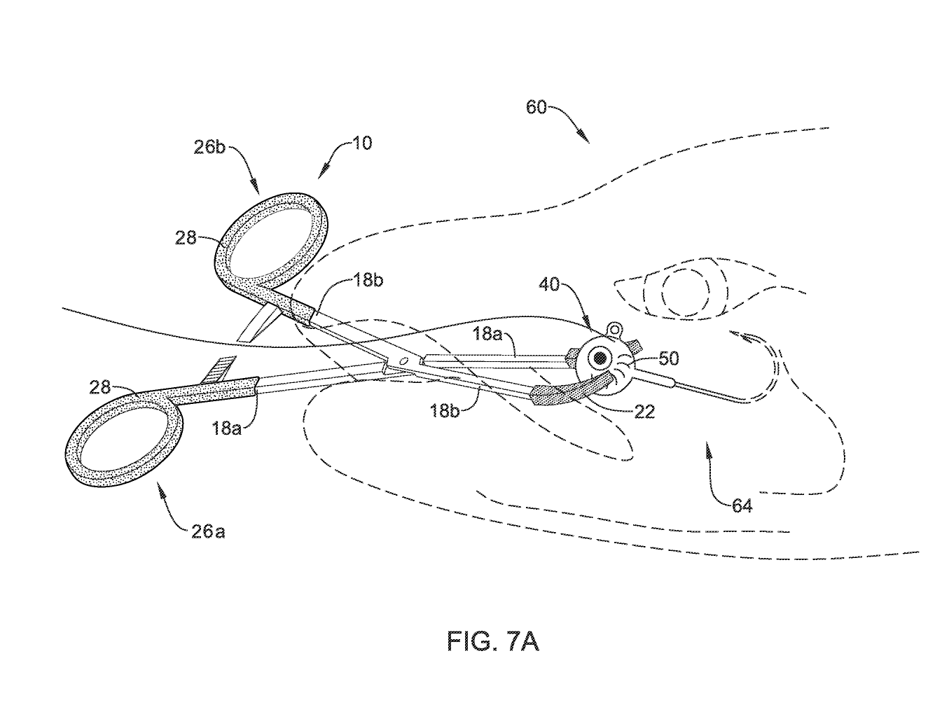

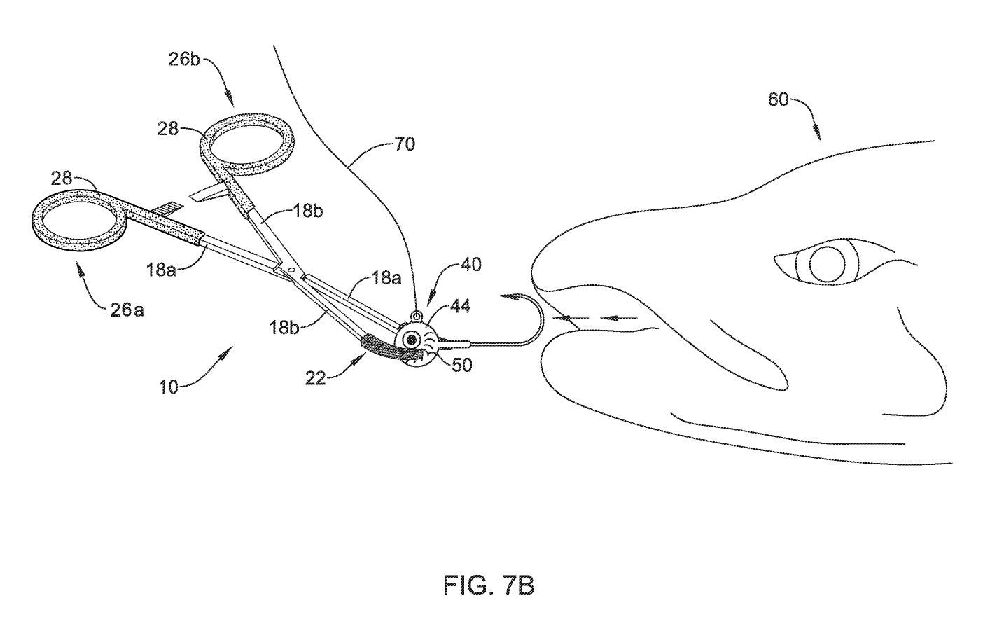

In some instances, the finger grips 26a, 26b may include coverings, such as are shown in the second example in FIGS. 7A and 7B. The coverings 28 are shown in the form of a coating over a portion of the rigid material of the first and second arms 18a, 18b, proximate the first and second ends 14a, 14b. In the example, the coverings may be constructed of the same pliable material as is used at distal tip portions 20a, 20b. It will be appreciated that the coverings 28 at the finger grips 26a, 26b may be constructed of similar or different materials than those provided as examples for the coverings 22.

FIG. 1 shows fishing lure remover 10 in a first position. In some instances, the first position of fishing lure remover 10 may be defined as an “open” position. As shown, the first ends 12a, 12b of arms 18a, 18b are spaced apart from one another, creating open space 30. Open space 30 may allow fishing lure remover 10 to receive an object placed therebetween for engaging and gripping (pinching, squeezing, clasping, etc.).

As discussed above, in some instances (e.g., when removing a fishing lure), it may be desirable to utilize fishing lure remover 10 to grip an object in order to manipulate the object through the application of torque or other forces, such as pushing or pulling, for example. Therefore, in some instances it may be desirable to close and/or lock fishing lure remover 10 around a fishing lure in order to remove the fishing lure from a fish. It is contemplated that elongated arms 18a, 18b may be elongated such that the arms 18a, 18b may be capable of extending into the body cavity of a fish and to engage a hook swallowed by a fish.

As discussed above, in some instances fishing lure remover 10 may be shifted from a first position to a second position. A second position may include a position in which the interior surface of the first and second elongated members are touching each other or are touching an adjacent surface. For example, a second position may include a position where first end 12a of first arm 18a is directly contacting first end 12b of second arm 18b. Additionally, a second position may include a position where first arm 18a is contacting a surface of an object and second arm 18b is contacting another portion of the surface of the same object. In other words, a second position may include instances where arms 18a, 18b are pressing against one another and, additionally, may include instances where arms 18a, 18b are pressing against an object positioned therebetween (e.g., at least partially filling the open space 30). As such, the second position of fishing lure remover 10 may be defined as a “closed” position.

FIG. 2 depicts fishing lure remover 10 in an illustrative second position. As shown in FIG. 2, arms 18a, 18b and distal tips portions 20a, 20b may contact one another in the closed position. It will be understood that in some instances, an open space 30 may not exist between arms 18a, 18b when in the second position.

In some embodiments, arms 18a, 18b may lock together. In one example, locking elements 15 capable of engaging one another may be positioned at or near finger grips 26a, 26b and may facilitate locking together arms 18a, 18b. In some cases, locking elements 15 may include mating surfaces that interlock when brought in contact with one another. For example, as finger grips 26a, 26b are brought closer together, locking elements 15 may interlock with one another, preventing arms 18a, 18b from moving away from one another. Illustratively, locking elements 15 may include one or more notched portions that represent complementary grooves and protrusions that may be engaged and/or mate with one another to interlock arms 18a, 18b. Alternatively, or in addition, locking elements 15 may engage one another with a magnetic pull, a snap engagement, or other engaging mechanism, and may be unitarily formed with the first and second arms 18a, 18b, or connected thereto.

FIG. 2 shows locking elements 15 interlocked with each other, thereby holding fishing lure remover 10 in a second, or closed, position. Furthermore, in at least some embodiments, locking elements 15 may interlock in an adjustable manner so as to be capable of interlocking even as fishing hook remover 10 is gripping an object between distal tip portions 20a, 20b. In the example shown, locking elements 15 may be released by squeezing the arms 18a, 18b to move the second ends 14a, 14b closer toward each other while applying force to separate them laterally.

As discussed above, some or a portion of first and/or second arms 18a, 18b may have a covering constructed of a pliable material. The pliable material of coverings 22 may flex, conform, bend, yield, etc., to accommodate a variety of shapes of an object that an angler may place against the coverings 22. The pliable material that conforms and/or yields to an object placed against it may provide a cushion around the object such that the object and its surface finish are not damaged as arms 18a, 18b are inserted into a mouth of a fish and/or are moved from a first, open position to a second, closed position around the object.

The coverings 22 may cover a portion of or all of arms 18a, 18b. The first example in FIGS. 1 and 2 is depicted with coverings 22 constructed of a pliable material that covers a portion of arms 18a, 18b. It also is contemplated, as shown with the second example in FIGS. 7A and 7B, that coverings 28 constructed of a pliable material may cover some or all of finger grips 26a, 26b, to provide protective, cushioned and/or insulated finger grips.

In some instances, coverings 22 and/or coverings 28 may be constructed of a resilient material. The resilient material may be able to recoil and/or relax to a resting state after being flexed, conformed, bent, stretched, compressed, or the like. It may be beneficial for the pliable material to be resilient, so as to have the ability to resume and/or regain its original shape after being conformed to the shape of a gripped object. For example, it may be beneficial for the pliable material of coverings 22 and/or coverings 28 to return to their resting shape after fishing lure remover 10 has been used to grip and/or remove a fishing lure.

The pliable material of coverings 22 for the distal tip portions 20a, 20b and/or coverings 28 for the finger grips 26a, 26b may be made from a variety of materials. For example, in at least some embodiments described herein, the pliable material may include rubber, foam, fabric, vinyl, at least some polyvinylchloride (PVC), or other suitable materials that may provide cushioned engagement with an object or fingers. These are merely examples and are not intended to be limiting, as many additional materials are contemplated.

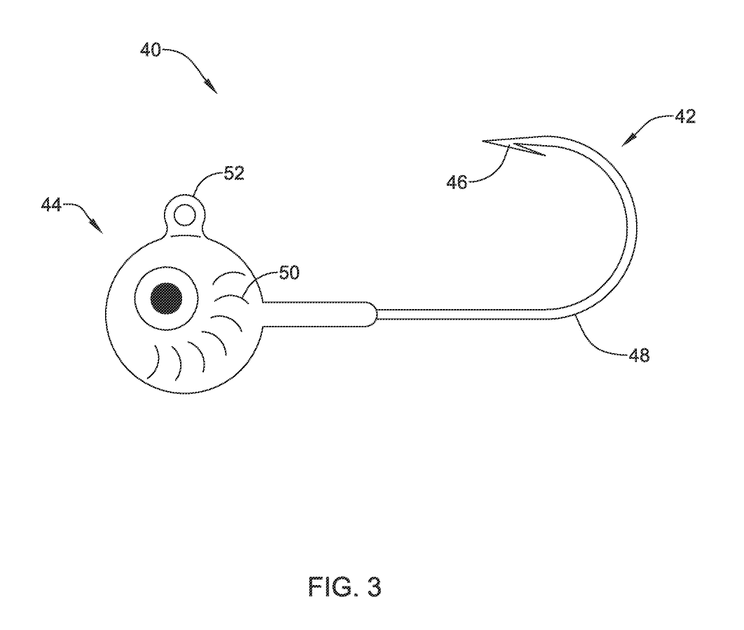

FIG. 3 shows an example fishing lure 40. Fishing lure 40 may include a hook portion 42 coupled to or unitarily formed with body portion 44. Hook portion 42 may include barb 46 and barb support wire 48. Barb 46 may be positioned at a distal portion of barb support wire 48. Body portion 44 may include an eyelet 52 as shown in FIG. 3.

FIG. 3 shows body portion 44 shaped as generally spherical. However, it is contemplated that body portion 44 may be a variety of shapes and or configurations. For example, body portion 44 may be elongated, cylindrical, ovular, flat, arcuate, etc. Further, body portion 44 may resemble that of a fish, minnow, worm, or other live bait, or the like.

Fishing lure 40 made be constructed from a variety of materials. In at least some embodiments contemplated herein, fishing lure 40 may be constructed, in part, of a metal, metal alloy, polymer, plastic, ceramic, rubber, or other suitable material. For example, fishing lure 40 may be constructed from tungsten, which is just an example, while other materials are contemplated.

In addition to that discussed above, fishing lure 40 may include a surface finish on its outer surface. For example, FIG. 3 depicts a surface finish 50 applied to the outer surface of fishing lure 40. Surface finish 50 may be constructed of a variety of different substances, and may be in any of a number of different configurations. For example, surface finish 50 may include one or more paints, polishes, stains, or the like. Furthermore, surface finish 50 (e.g., paint, polish, stain, etc.) may include a variety of colors, sheens, thicknesses, viscosities, etc.

Surface finish 50 also may include a surface roughness, texture or other surface treatment, or the like. For example, surface finish 50 may have a rough surface, smooth surface, patterned surface, or the like. The surface texture may be created via any of a number of different manufacturing methods. Indeed, one skilled in the art will appreciate a variety of methods may be used to create a surface texture as part of the surface finish 50 on the outer surface of fishing lure 40.

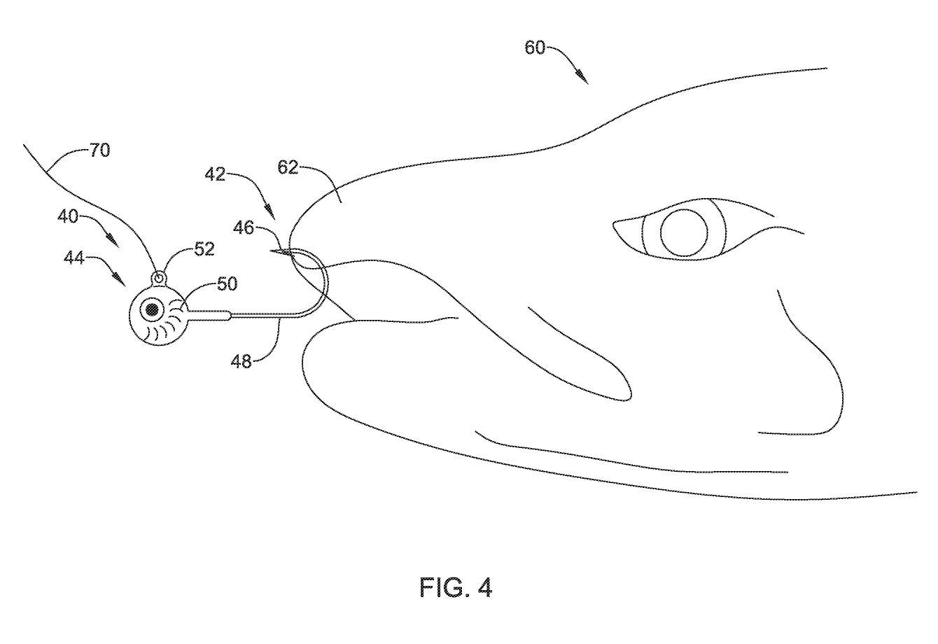

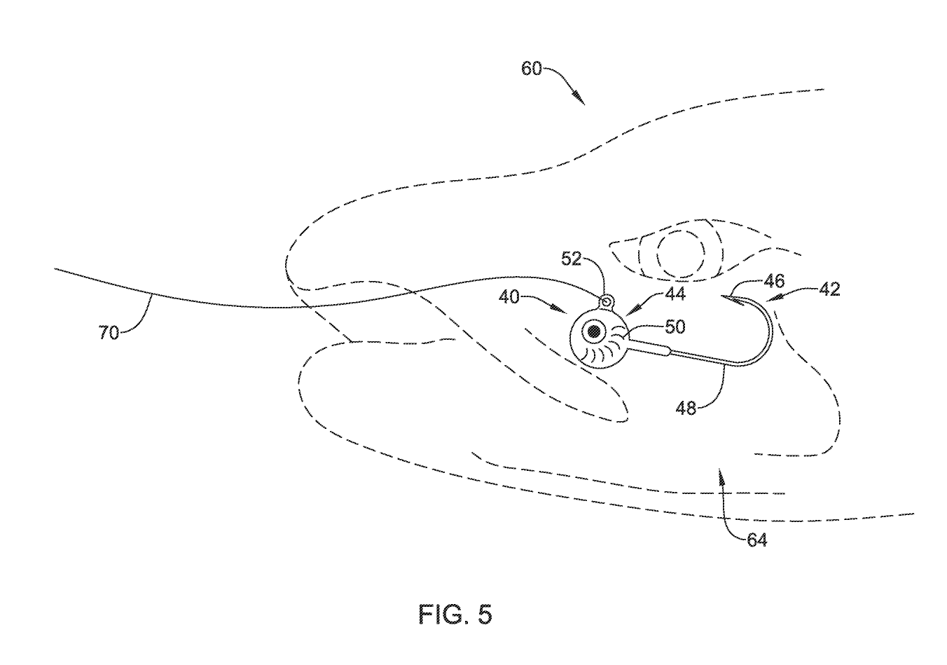

FIGS. 4 and 5 show example fishing lure 40 hooked into an example fish 60. In FIG. 4, example fishing lure 40 is hooked through the lip 62 of fish 60. In FIG. 5, example fishing lure 40 is shown hooked in the body cavity 64 of fish 60.

As is shown in FIG. 4, barb 46 may penetrate lip 62 and, in some instances, may make fishing lure 40 difficult to remove. To assist in removing the fishing lure 40, the fishing lure remover 10 may grip and/or clasp the body portion 44 and an angler may apply a torque, pushing and/or pulling force to remove the fishing lure 40 from the fish 60. In some instances, removing fishing lure 40 from lip 62 and/or body cavity 64 of fish 60 may require fishing lure remover 10 to be inserted into body cavity 64, where it may engage the fishing lure 40 and be used to grip fishing lure 40 about body portion 44 and/or barb support wire 48. The angler then may apply a torque, pushing and/or pulling force, as needed, to remove fishing lure 40 from body cavity 64.

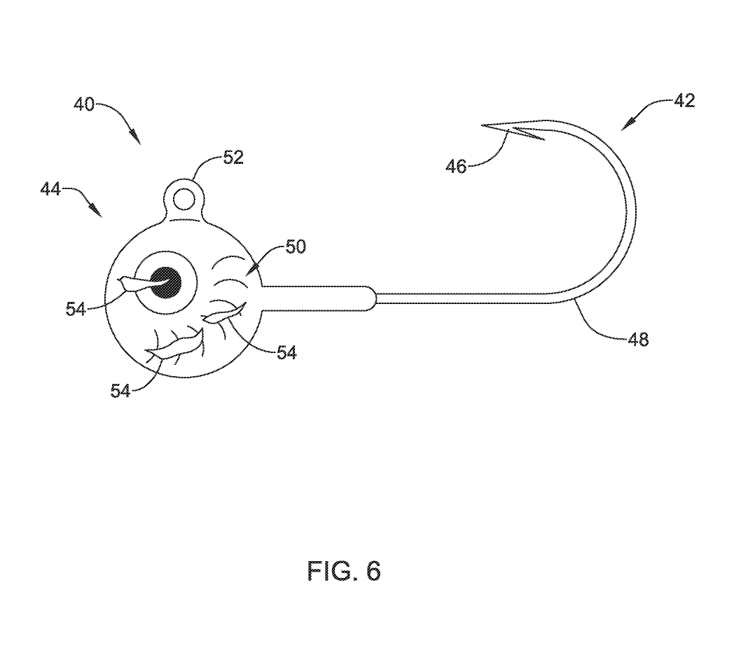

It can be appreciated that gripping fishing lure 40 about body portion 44 and/or barb support wire 48 and applying a force to remove fishing lure 40 without coverings 22 may result in areas 54 of the surface finish 50 being removed, scratched, scuffed and/or otherwise damaged. For example, FIG. 6 shows example fishing lure 40 having a portion of surface finish 50 damaged and/or removed. The extent to which an angler may apply force to manipulate and/or remove fishing lure 40 may directly impact the areas 54 and degree to which the surface finish 50 is scratched, scuffed, damaged and/or removed from the outer surface of fishing lure 40, in the absence of coverings 22. However, utilizing fishing lure remover 10 with coverings 22 having a pliable material at a distal end to grip a fishing lure may allow for engaging, gripping and/or removal of fishing lure without damaging the surface finish of the fishing lure.

An example method of gripping a fishing lure may include engaging a fishing lure with a fishing lure remover disclosed in any of the embodiments described and contemplated herein. For example, the method may include engaging a fishing lure 40 with a portion of a first arm 18a having a covering 22 that is constructed of a pliable material and engaging the fishing lure 40 with a portion of a second arm 18b having a covering 22 that is constructed of a pliable material. The example method for gripping a fishing lure may further include holding the fishing lure between the coverings 22 on the first and second arms 18a, 18b while moving the fishing lure from a first location to a second location.

FIGS. 7A and 7B illustrate a second example fishing lure that differs from the first only in that it further includes the aforementioned coverings 28 over the finger grips 26a, 26b. FIGS. 7A and 7B also show an example methodology for gripping and removing a fishing lure from a hooked location in a fish utilizing the methodology discussed above. As shown in FIG. 7A and discussed above, fishing lure 40 may get hooked in a first location in a fish 60 within body cavity 64 of fish 60. In at least one example embodiment, an angler may insert fishing lure remover 10 inside fish 60 in an effort to engage and grip the fishing lure 40. The method may further include holding the fishing lure 40 and removing fishing lure 40 to a second location outside fish 60.

In some instances, an example method may further include engaging a fishing lure 40 around the body portion 44 of the fishing lure 40. Further, the method may include locating the fishing lure 40 between the arms 18a, 18b when engaged by the coverings 22 of pliable material on the first and second arms, such that the pliable material coverings 22, rather than the rigid material of uncovered portions of arms 18a, 18b, engage the surface finish 50 of the fishing lure 40.

For example, FIG. 7B shows example fishing lure 40 in the second location after being removed from body cavity 64 of fish 60. As shown in FIG. 7B, the surface finish 50 on example fishing lure 40 has not been scratched, scuffed, removed, damaged, etc. FIG. 7B shows fishing lure remover 10 gripping body portion 44 of fishing lure 40 by contacting the body portion 44 along the first and second arms 18a, 18b at the pliable material coverings 22, rather than uncovered portions of the fishing lure remover 10. As discussed above, the properties of the pliable coating may allow the surface finish 50 of the fishing lure 40 to remain intact despite torsional, pushing, pulling, frictional, or other forces being applied thereon.

While FIGS. 7A and 7B define first and second locations as relating to moving fishing lure 40 from inside to outside a fish 60. In some instances, the methodology may contemplate gripping and moving a fishing lure in accordance with methodologies disclosed herein when applying a bait to the fishing lure, coupling a line to the fishing lure, or the like.

For example, when applying bait to the fishing lure, it may be desirable to grip body portion 44 of the fishing lure 40 between the coverings 22 of pliable material disposed on portions of respective first and second arms 18a, 18b. Additionally, it may be desirable to lock fishing lure remover 10 in a second, or closed, position prior to applying and/or removing bait. Gripping the fishing lure 40 with the fishing lure remover 10 in a closed position may allow an angler to manipulate, anchor, and/or support the fishing lure while applying bait thereto and/or removing therefrom.

When coupling a fishing line 70 to fishing lure 40, it may be desirable to grip body portion 44 of the fishing lure 40 between the coverings 22 of pliable material disposed on the respective first and second arms 18a, 18b. It may also be desirable to lock fishing lure remover 10 in a second, or closed, position prior to tying or coupling a fishing line to the fishing lure 40. Gripping the fishing lure 40 with the fishing lure remover 10 in a closed position may facilitate maintaining a position of and/or controlling the fishing lure 40 while coupling a fishing line 70 thereto.

It should be understood that this disclosure is, in many respects, only illustrative. Changes may be made in details, particularly in matters of shape, size, materials and arrangement of steps without exceeding the scope of the invention. This may include, to the extent that it is appropriate, the use of any of the features of one example embodiment being used in other embodiments. The scope of the invention is not limited to the embodiments described above but rather is defined by the appended claims.

What is claimed is:

1. A method of gripping a fishing lure, the method comprising:
engaging a fishing lure with a portion of a first arm having a covering that is constructed of a pliable material;
engaging the fishing lure with a portion of a second arm having a covering that is constructed of a pliable material;
holding the fishing lure between the coverings on the first and second arms while moving the fishing lure from a first location to a second location.

2. The method of claim 1, wherein:
the first arm has a first end and a second end;
the second arm has a first end and a second end;
the covering on the first arm being located at the first end and the covering on the second arm being located at the first end; and
the first and second arms are coupled together via a pivot engaging the first and second arms at a location between the first end and the second end of each of the first and second arms.

3. The method of claim 2, wherein:
the covering on the first end of the first arm is a coating; and
the covering on the first end of the second arm is a coating.

4. The method of claim 1, wherein the fishing lure includes a body portion and a hook portion, and wherein holding the fishing lure includes engaging at least one of the body portion and hook portion between the coverings on the first and second arms.

5. The method of claim 4, wherein the first arm and the second arm are metal, and wherein the coverings on the first and second arms overlay the metal of the first and second arms.

6. The method of claim 1, wherein the coverings on the first and second arms are constructed of a resilient material.

7. The method of claim 1, wherein:
the first arm has a first end having a distal tip and a second end having a finger grip;
the second arm has a first end having a distal tip and a second end having a finger grip;
the portion of the first arm having a covering further comprising the distal tip and the finger grip, and the portion of the second arm having a covering further comprising the distal tip and the finger grip; and
the first and second arms being coupled together via a pivot engaging the first and second arms at a location between the first ends and the second ends of the first and second arms.

8. The method of claim 1, further comprising:
coupling a string to the fishing lure while holding the fishing lure between the first and second arms.

9. The method of claim 1, further comprising:
removing the fishing lure from a fish while holding the fishing lure between the first and second arms.

10. The method of claim 1, further comprising:
applying bait to the fishing lure while holding the fishing lure between the first and second arms.

11. A method of removing a fishing lure from a fish with a fishing lure remover, the method comprising:
gripping a fishing lure at least partially hooked in a fish between a covering on at least a portion of a first end of a first arm of a fishing lure remover and a covering on at least a portion of a first end of a second arm of the fishing lure remover, wherein the coverings are constructed of a pliable material and the first arm is coupled to the second arm; and
removing the fishing lure from the fish while gripping the fishing lure between the coverings on the respective first and second arms.

12. The method of claim 11, further comprising:
maintaining a surface finish of the fishing lure at a location at which the fishing lure is gripped by the coverings while removing the fishing lure from the fish.

13. The method of claim 12, wherein gripping the fishing lure further comprises gripping a fishing lure having a surface finish that includes a paint, a polish, or a surface texture.

14. The method of claim 12, wherein gripping the fishing lure further comprises gripping a fishing lure having at least a portion of the fishing lure constructed of a tungsten material.

15. The method of claim 11, further comprising:
inserting into a fish at least part of the coverings on the first ends of the first and second arms.

16. The method of claim 11, further comprising:
moving the first and second arms into a first position having a space therebetween; and
engaging the fishing lure with the coverings on the first and second arms at least partially around the fishing lure.

17. The method of claim 16, further comprising:
locking the first and second arms in a second position to maintain a grip on the engaged fishing lure.

18. The method of claim 11, wherein the coverings cover a rigid material of the respective first and second arms.

19. A fishing lure remover configured to grip a fishing lure while maintaining a surface finish on the fishing lure, comprising:
a first arm having a first end including an elongated portion terminating in a distal tip and a second end including a finger grip, wherein at least a portion of the first arm is constructed of a rigid material;
a second arm having a first end including an elongated portion terminating in a distal tip and a second end including a finger grip, wherein at least a portion of the second arm is constructed of a rigid material;
the second arm being pivotally coupled to the first arm between the respective first ends and second ends so as to be pivotally movable between a first position and a second position;
coverings on the distal tips of the respective first ends of the first and second arms, wherein the coverings are constructed of a pliable material; and
wherein when the first and second arms are in the second position, the coverings are configured to releasably grip a fishing lure while maintaining a surface finish on the fishing lure.

20. The fishing lure remover of claim 19, further comprising additional coverings being located on the finger grips at the second ends of the first and second arms and being constructed of a pliable material.
